(19) United States
(12) Patent Application Publication
(10) Pub. No.: US 2023/0099906 A1
(43) Pub. Date: Mar. 30, 2023

(54) IMAGE REGISTRATION METHOD, COMPUTER DEVICE, AND STORAGE MEDIUM

(71) Applicant: SHANGHAI UNITED IMAGING HEALTHCARE Co., LTD., Shanghai (CN)

(72) Inventor: XIN WENG, Shanghai (CN)

(21) Appl. No.: 17/952,254

(22) Filed: Sep. 25, 2022

(30) Foreign Application Priority Data
Sep. 29, 2021 (CN) 202111148982.5

(51) Int. Cl. G06T 7/33; G06T 3/40

(52) U.S. Cl. CPC G06T 7/337; G06T 3/40; G06T 2207/20081

(57) ABSTRACT

An image registration method, a computer device, and a non-transitory storage medium. The method includes: acquiring a target moving image and a target reference image to be registered, the target moving image and the target reference image being scanned medical images with the same dimension; and performing a registration process on the target moving image and the target reference image by using a pre-trained image registration model to obtain a target registration parameter. The image registration model is a deep learning model for performing registration process on a moving image and a reference image between which a scan field of view difference is greater than a predetermined difference value. The method can improve registration efficiency.

### CROSS-REFERENCE TO RELATED APPLICATIONS

This application claims priority to Chinese patent application No. 202111148982.5, filed on Sep. 29, 2021 and entitled “IMAGE REGISTRATION METHOD AND APPARATUS, COMPUTER DEVICE, AND STORAGE MEDIUM”, the content of which is hereby incorporated by reference in its entirety.

### TECHNICAL FIELD

The present application relates to the field of image processing technology, and more particularly, to an image registration method and apparatus, a computer device, and a non-transitory storage medium.

### BACKGROUND

Image fusion is used to perform fusion processing on image data sampled at different times or from different measurements to obtain a fused image, or perform a lesion contour transfer operation, etc., so that the medical detection result is more objective and may reflect more details.

In the related art, prior to the image fusion, the image data sampled at different time or by different modes usually need to be registered first. Since the sampled image data often have a problem that there is a great difference in scan field of views (FOVs). For this case, a common registration method includes: using normalized mutual information as a similarity measurement, using positions in which fireflies are located to represent registration parameters, calculating a mutual information function value according to the position of each of the fireflies and using the value of the mutual information function as a luminance of a current firefly, and finding out a registration parameter corresponding to an optimal solution of the mutual information function obtained by iteratively updating the luminance and an attractiveness.

However, in the above-mentioned registration method, continuous iterations are required to find a preferable registration parameter, and therefore, there is a problem of a slow convergence rate and low registration efficiency.

### SUMMARY

In view of the above technical problem, it is necessary to provide an image registration method and apparatus, a computer device, and a non-transitory storage medium that may shorten registration time and improve the registration efficiency.

In a first aspect, an image registration method is provided. The method includes: acquiring a target moving image and a target reference image to be registered, the target moving image and the target reference image being scanned medical images with the same dimension, and performing a registration process on the target moving image and the target reference image by using a pre-trained image registration model to obtain a target registration parameter, the image registration model being a deep learning model for performing registration process on a moving image and a reference image between which a scan field of view difference is greater than a predetermined difference value.

In one of the embodiments, the performing the registration process on the target moving image and the target reference image by using the pre-trained image registration model to obtain the target registration parameter includes: performing an image pre-processing on the target moving image and the target reference image respectively to obtain an input moving image and an input reference image, inputting the input moving image and the input reference image into the image registration model to obtain an initial registration parameter, and performing a post-processing on the initial registration parameter to obtain the target registration parameter.

In one of the embodiments, the performing the image pre-processing on the target moving image and the target reference image respectively to obtain the input moving image and the input reference image includes: performing a downsampling processing on the target moving image and the target reference image respectively to obtain a sampled moving image and a sampled reference image, and performing an edge-expanding processing on the sampled moving image and the sampled reference image respectively to obtain the input moving image and the input reference image.

In one of the embodiments, the method further includes: performing a bed removal on the input moving image and the input reference image to obtain a bed-removed input moving image and a bed-removed input reference image.

Correspondingly, the inputting the input moving image and the input reference image into the image registration model to obtain an initial registration parameter includes: inputting the bed-removed input moving image and the bed-removed input reference image into the image registration model to obtain the initial registration parameter.

In one of the embodiments, before the performing the registration process on the target moving image and the target reference image by using the pre-trained image registration model to obtain the target registration parameter, the method comprises a training process of the image registration model, and the training process of the image registration model includes: acquiring moving image samples and reference image samples, training a deep learning model by using one sample group including a moving image sample and a reference image sample to obtain a transformation matrix, generating an auxiliary moving image and an auxiliary reference image according to a predetermined size, the moving image sample, and the reference image sample, performing an image transformation processing on the auxiliary moving image according to the transformation matrix to obtain a transformed auxiliary moving image, calculating an image similarity loss value according to the transformed auxiliary moving image and the auxiliary reference image, calculating a translation amount loss value according to an anatomical key point in the moving image sample and a corresponding anatomical key point in the reference image sample, adjusting model parameters of the deep learning model based on the image similarity loss value and the translation amount loss value to obtain the image registration model, and returning to perform step of training the deep learning model by using one sample group including the moving image sample and the reference image sample to obtain the transformation matrix, till a training loss value is convergent and less than a loss value threshold to obtain the pre-trained image registration model.

In one of the embodiments, the deep learning model includes a rigid registration model, and the training the deep learning model by using one sample group comprising the moving image sample and the reference image sample to obtain the transformation matrix includes: inputting the moving image sample and the reference image sample into the rigid registration model to obtain transformation parameters outputted by the rigid registration model, and performing a matrix transformation processing on the transformation parameters to obtain the transformation matrix.

In one of the embodiments, the deep learning model the deep learning model includes an affine registration model, and the training the deep learning model by using one sample group comprising the moving image sample and the reference image sample to obtain the transformation matrix includes: inputting the moving image sample and the reference image sample into the affine registration model to obtain the transformation matrix outputted by the affine registration model.

In one of the embodiments, the adjusting model parameters of the deep learning model based on the image similarity loss value and the translation amount loss value to obtain the image registration model includes: calculating a weighted sum of the image similarity loss value and the translation amount loss value to obtain a total loss value, and adjusting the model parameters of the deep learning model based on the total loss value to obtain the image registration model.

In one of the embodiments, the step of acquiring moving image samples and reference image samples includes: selecting a candidate moving image and a candidate reference image from the predetermined sample set, the candidate moving image and the candidate reference image having corresponding anatomical key points at corresponding positions, performing an image cropping processing on the candidate moving image and the candidate reference image respectively to obtain cropped moving images and cropped reference images, and performing an image pre-processing on the cropped moving images and the cropped reference images to obtain the moving image samples and the reference image samples.

In one of the embodiments, after the performing the registration process on the target moving image and the target reference image by using the pre-trained image registration model to obtain the target registration parameter, the method further includes: performing a transformation processing on the target moving image according to the target registration parameter to obtain a transformed moving image, and performing a registration process on the transformed moving image and the target reference image by using a predetermined rigid registration model and/or a predetermined non-rigid registration model to obtain an updated registration parameter.

In one of the embodiments, the method further includes a process of merging images, and the process of merging images includes: acquiring a target transfer image corresponding to the target moving image, and merging the target transfer image and the target reference image according to the target registration parameter to obtain a target merged image.

In a second aspect, an image registration apparatus is provided. The apparatus includes: an image acquisition module and a registration process module.

The image acquisition module is configured to acquire a target moving image and a target reference image to be registered. The target moving image and the target reference image are scanned medical images with the same dimension.

The registration process module 602 is configured to perform a registration process on the target moving image and the target reference image by using a pre-trained image registration model to obtain a target registration parameter. The image registration model is a deep learning model for performing registration process on a moving image and a reference image between which a scan field of view (FOV) difference is greater than a predetermined difference value.

In one of the embodiments, the registration process module includes a pre-processing submodule, a registration submodule, and a post-processing submodule.

The pre-processing submodule is configured to perform an image pre-processing on the target moving image and the target reference image respectively to obtain an input moving image and an input reference image.

The registration submodule is configured to input the input moving image and the input reference image into the image registration model to obtain an initial registration parameter.

The post-processing submodule is configured to perform a post-processing on the initial registration parameter to obtain the target registration parameter.

In one of the embodiments, the pre-processing submodule is specifically configured to perform a downsampling processing on the target moving image and the target reference image respectively to obtain a sampled moving image and a sampled reference image, and perform an edge-expanding processing on the sampled moving image and the sampled reference image respectively to obtain the input moving image and the input reference image.

In one of the embodiments, the above registration process module further includes a bed removal submodule.

The bed removal submodule is configured to perform a bed removal processing on the input moving image and the input reference image to obtain a bed-removed input moving image and a bed-removed input reference image.

Correspondingly, the registration submodule is specifically configured to input the bed-removed input moving image and the bed-removed input reference image into the image registration model to obtain the initial registration parameter.

In one of the embodiments, the apparatus includes a sample acquisition module, a model training module, an auxiliary image generation module, a first image transformation module, a first loss calculation module, a second loss calculation module, and a parameter adjustment module.

The sample acquisition module is configured to acquire moving image samples and reference image samples.

The model training module is configured to train a deep learning model by using one sample group including a moving image sample and a reference image sample to obtain a transformation matrix.

The auxiliary image generation module is configured to generate an auxiliary moving image and an auxiliary reference image according to a predetermined size, the moving image sample, and the reference image sample.

The first image transformation module is configured to perform an image transformation processing on the auxiliary moving image according to the transformation matrix to obtain a transformed auxiliary moving image.

The first loss calculation module is configured to calculate an image similarity loss value according to the transformed auxiliary moving image and the auxiliary reference image.

The second loss calculation module is configured to calculate a translation amount loss value according to an anatomical key point in the moving image sample and a corresponding anatomical key point in the reference image sample.

The parameter adjustment module is configured to adjust model parameters of the deep learning model based on the image similarity loss value and the translation amount loss value to obtain the image registration model.

In one of the embodiments, the deep learning model includes a rigid registration model, and the above model training module is specifically configured to input the moving image sample and the reference image sample into the rigid registration model to obtain transformation parameters outputted by the rigid registration model, and perform a matrix transformation processing on the transformation parameters to obtain the transformation matrix.

In one of the embodiments, the deep learning model includes an affine registration model, and the model training module is specifically configured to input the moving image sample and the reference image sample into the affine registration model to obtain the transformation matrix outputted by the affine registration model.

In one of the embodiments, the above parameter adjustment module is specifically configured to calculate a weighted sum of the image similarity loss value and the translation amount loss value to obtain a total loss value, and adjust the model parameters of the deep learning model based on the total loss value to obtain the image registration model.

In one of the embodiments, the sample acquisition module is specifically configured to select a candidate moving image and a candidate reference image from the predetermined sample set. The candidate moving image and the candidate reference image have corresponding anatomical key points at corresponding positions. The sample acquisition module is specifically configured to perform an image cropping processing on the candidate moving image and the candidate reference image respectively to obtain cropped moving images and cropped reference images, and is configured to perform an image pre-processing on the cropped moving images and the cropped reference images to obtain the moving image samples and the reference image samples.

In one of the embodiments, the apparatus further includes a second image transformation module and a parameter updating module.

The second image transformation module is configured to perform a transformation processing on the target moving image according to the target registration parameter to obtain a transformed moving image.

The parameter updating module is configured to perform a registration process on the transformed moving image and the target reference image by using a predetermined rigid registration model and/or a predetermined non-rigid registration model to obtain an updated registration parameter.

In a third aspect, the image registration apparatus of the present disclosure further includes an image merging unit. The image merging unit includes an image acquisition module and a merging module.

The image acquisition module is configured to acquire a target transfer image corresponding to the target moving image.

The merging module is configured to merge the target transfer image and the target reference image according to the target registration parameter to obtain a target merged image.

In a fourth aspect, a computer device is provided. The computer device includes a memory and a processor. Computer programs are stored on the memory. The processor, when executing the computer programs, performs the method of the first aspect.

In a fifth aspect, the present disclosure provides a non-transitory computer readable storage medium, on which computer programs are stored, and the computer programs, when being executed by a processor, cause the processor to perform the method of the first aspect.

In the above image registration method and apparatus, the computer device, and the storage medium, the target moving image and the target reference image to be registered are acquired, the target moving image and the target reference image are scanned medical images with the same dimension. The registration process is performed on the target moving image and the target reference image by using the pre-trained image registration model to obtain the target registration parameter. The image registration model is a deep learning model for performing registration process on the moving image and the reference image between which the scan field of view difference is greater than the predetermined difference value. Compared with the registration approach in the related art, by using the above image registration model to perform registration, the embodiments of the present disclosure find out the registration parameter without iteration and accordingly do not have the problem of slow convergence, thereby shortening the registration time and improving the registration efficiency.

### BRIEF DESCRIPTION OF THE DRAWINGS

FIG. 1 is an application environment view of an image registration method in an embodiment.

FIG. 2 is a schematic flow chart of the image registration method in an embodiment.

FIG. 3 is a schematic flow chart of a process of obtaining a target registration parameter in an embodiment.

FIG. 4 is a first schematic flow chart of a process of pre-processing an image in an embodiment.

FIG. 5 is a second schematic flow chart of the process of pre-processing the image in an embodiment.

FIG. 6 is a schematic flow chart of a process of training an image registration model in an embodiment.

FIG. 7a is a first schematic view illustrating anatomical key points in an embodiment.

FIG. 7b is a second schematic view illustrating the anatomical key points in an embodiment.

FIG. 8a is a first schematic view illustrating a result of registration in an embodiment.

FIG. 8b is a second schematic view illustrating the result of registration in an embodiment.

FIG. 9 is a structural schematic view illustrating a rigid registration model in an embodiment.

FIG. 10 is a schematic flow chart of the image registration method in another embodiment.

FIG. 11 is a schematic flow chart of a process of merging images in an embodiment.

FIG. 12 is a structural block diagram illustrating an image registration apparatus in an embodiment.

FIG. 13 is a structural block diagram illustrating an image merging unit in an embodiment.

FIG. 14 is a view illustrating an internal structure of a computer device in an embodiment.

### ON OF THE EMBODIMENTS

To make the purposes, technical solutions and advantages of the present disclosure to be clearer and better understood, the present disclosure will be described in detail herein with reference to the accompanying drawings and embodiments. It should be understood that the specific embodiments described herein are only used to explain the present disclosure, but not intended to limit the present disclosure.

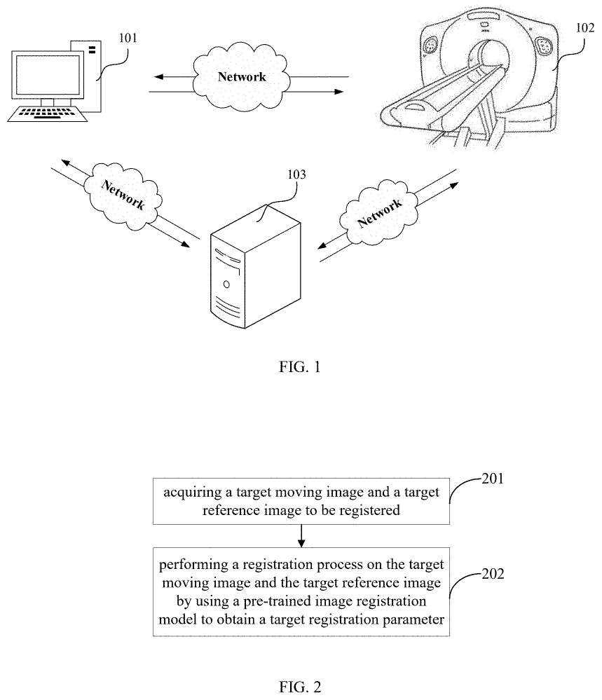

The image registration method provided in the present disclosure may be applied to the application environment shown in FIG. 1. The application environment may include a computer device 101 and a medical scanning device 102. The computer device 101 may communicate with the medical scanning device 102 through a network. The computer device 101 maybe, but is not limited to, any one of various personal computers, notebook computers, and tablet computers. The above medical scanning device 102 may be, but is not limited to, a computed tomography (CT) device, a positron emission-computed tomography (PET-CT) device, or a magnetic resonance (MR) device.

The application environment may further include a picture archiving and communication system (PACS) server 103, and both the computer device 101 and the medical scanning device 102 may communicate with the PACS server 103 through a network. The PACS server 103 may be implemented by using an independent server or a server cluster composed of multiple servers.

In an embodiment, as shown in FIG. 2, an image registration method is provided. Taking the method applied to the computer device 101 in FIG. 1 as an example for illustration, the method includes the following steps 201 and 202.

In step 201, a target moving image and a target reference image to be registered are acquired.

The target moving image and the target reference image are scanned medical images with the same dimension. For example, the target moving image and the target reference image are both scanned three-dimensional medical images, or, the target moving image and the target reference image are both scanned two-dimensional medical images. The scanned medical image may be at least one of a CT image, an MR image, and a PET-CT image.

The computer device may acquire the target moving image and the target reference image to be registered from the medical scanning device, or may acquire the target moving image and the target reference image to be registered from the PACS server. The acquisition approach is not limited in the embodiments of the present disclosure.

In step 202, a registration process is performed on the target moving image and the target reference image by using a pre-trained image registration model to obtain a target registration parameter.

The image registration model is a deep learning model for performing a registration process on a moving image and a reference image between which a scan FOV difference is greater than a predetermined difference value. For example, the image registration model may include at least one of a convolutional neural network and a cyclic neural network. The predetermined difference value is not limited in the embodiments of the present disclosure.

The pre-trained image registration model is configured in the computer device, and after the target moving image and the target reference image are acquired, the target moving image and the target reference image are registered by using the image registration model, and the target registration parameter is obtained according to a result of the registration. Since the image registration model may perform the registration process on a moving image and a reference image between which a scan FOV difference is greater than a predetermined difference value, no iteration approach of the related art is needed to find out the registration parameter, and the registration time may be shortened.

In the above embodiment, the target moving image and the target reference image are acquired, and the registration process is performed on the target moving image and the target reference image by using the pre-trained image registration model to obtain the target registration parameter. The image registration model is a deep learning model for performing the registration process on the moving image and the reference image between which a scan FOV difference is greater than the predetermined difference value. Compared with the registration approach in the related art, by using the above image registration model to perform registration, the embodiments of the present disclosure find out the registration parameter without iteration and accordingly do not have the problem of slow convergence, thereby shortening the registration time and improving the registration efficiency.

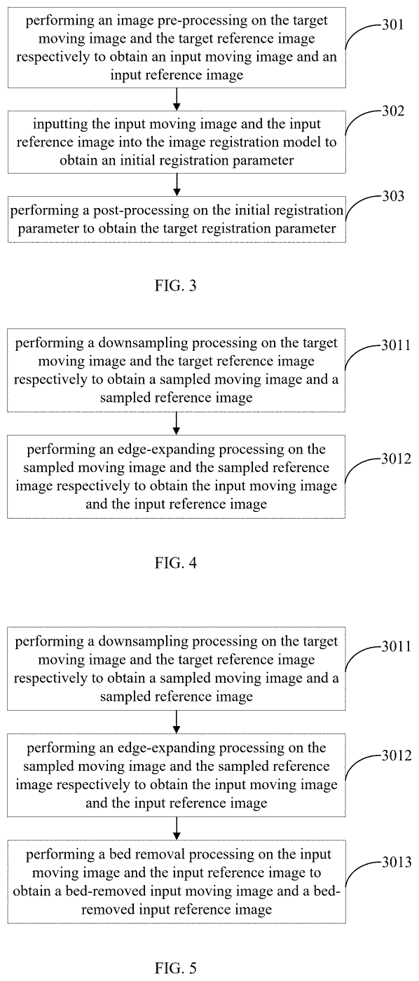

In an embodiment, as shown in FIG. 3, the step of performing the registration process on the target moving image and the target reference image by using a pre-trained image registration model to obtain the target registration parameter may include the following step 301 to step 303.

In step 301, an image pre-processing is performed on the target moving image and the target reference image respectively to obtain an input moving image and an input reference image.

In practical applications, the resolution and sizes of the target moving image and the target reference image may not be matched with the image registration model, and therefore, the image pre-processing is necessarily performed on the target moving image and the target reference image first. For example, a size transformation processing is performed on the target moving image and the target reference image. An approach of the image pre-processing is not limited in the embodiments of the present disclosure.

The image pre-processing is performed on the target moving image to obtain the input moving image, and the image pre-processing is performed on the target reference image to obtain the input reference image.

In step 302, the input moving image and the input reference image are inputted into the image registration model to obtain an initial registration parameter.

After obtaining the input moving image and the input reference image, the computer device inputs the input moving image and the input reference image into the image registration model, and the image registration model outputs the initial registration parameter.

In step 303, a post-processing is performed on the initial registration parameter to obtain the target registration parameter.

After obtaining the initial registration parameter outputted by the image registration model, the computer device performs the post-processing on the initial registration parameter according to the target moving image and the target reference image to obtain the target registration parameter.

For example, the computer device determines that a center point of the initial registration parameter deviates according to the target moving image and the target reference image, and then calibrates the initial registration parameter according to the deviation of the center point to obtain the target registration parameter. An approach of the post-processing is not limited in the embodiments of the present disclosure and may be set according to actual conditions.

In the above embodiment, the image pre-processing is performed on the target moving image and the target reference image respectively to obtain the input moving image and the input reference image. The input moving image and the input reference image are inputted into the image registration model to obtain the initial registration parameter. The post-processing is performed on the initial registration parameter to obtain the target registration parameter. According to the embodiment of the present disclosure, the image pre-processing may make the input image of the image registration model more adaptable to the image registration model, and by means of the post-processing for the initial registration parameter, more accurate target registration parameter may be obtained.

In an embodiment, as shown in FIG. 4, the performing image pre-processing on the target moving image and the target reference image respectively to obtain the input moving image and the input reference image includes step 3011 and step 3012.

In step 3011, a downsampling processing is performed on the target moving image and the target reference image respectively to obtain a sampled moving image and a sampled reference image.

Since the resolution of body data acquired by the medical scanning device is relatively fine, in order to balance the registration accuracy and the registration speed, the downsampling processing is usually performed on the target moving image and the target reference image in practical applications.

For example, the resolution of the target moving image and the target reference image is 1.5 mm, and the computer device performs down-sampling processing on the target moving image and the target reference image to obtain the sampled moving image and the sampled reference image. The resolution of the sampled moving image and the sampled reference image is 5 mm.

It may be understood that, the downsampling processing may not only ensure the registration accuracy, but also improve the registration speed and shorten the registration time.

In step 3012, an edge-expanding processing is performed on the sampled moving image and the sampled reference image respectively to obtain the input moving image and the input reference image.

The deep learning model performs the downsampling operation on the image, and therefore, the edge-expanding processing is necessarily to be performed on the images, so as to be adapted to the downsampling operation. For example, the edge-expanding processing is performed on the sampled moving image and the sampled reference image respectively to obtain the input moving image and the input reference image, and a length of a side of the input moving image and a length of a side of the input reference image are a multiple of 16.

The edge-expanding processing may be supplementing a black background around the original image, and an approach of the edge-expanding processing is not limited in the embodiments of the present disclosure.

As shown in FIG. 5, on the basis of the above embodiments, in an embodiment of the present disclosure, after the step 3012 of performing the edge-expanding processing on the sampled moving image and the sampled reference image respectively to obtain the input moving image and the input reference image, the image registration method of the present disclosure may further include step 3013.

In step 3013, a bed removal processing is performed on the input moving image and the input reference image to obtain a bed-removed input moving image and a bed-removed input reference image.

During the medical scan, the bed board is also scanned. Therefore, in order to eliminate the influence of the bed board and improve the registration accuracy, the computer device may further perform the bed removal processing on the input moving image and the input reference image to obtain the bed-removed input moving image and the bed-removed input reference image.

The bed plate removal processing may include: binarizing the image to obtain a binarized image; performing a connected domain analysis on the binarized image to obtain a bed board region; and setting a pixel value of the bed board region to a predetermined pixel value to obtain a bed-removed image. In practical applications, the bed removal approach may also be any other one, and is not limited in the embodiments of the present disclosure.

Alternatively, the computer device may perform not only the bed removal processing, but also a cropping processing to remove a redundant background in the image, thereby not only reducing an influence of the redundant background on the registration accuracy, but also reducing a video memory required for operation, and further increasing the registration speed and shortening the registration time.

Correspondingly, the step 302 may be: inputting the bed-removed input moving image and the bed-removed input reference image into the image registration model to obtain the initial registration parameter.

If the bed removal processing is further performed after the input moving image and the input reference image are obtained, then the bed-removed input moving image and the bed-removed input reference image are inputted into the image registration model to obtain the initial registration parameter outputted by the image registration model.

In the above embodiment, the downsampling processing is performed on the target moving image and the target reference image respectively to obtain the sampled moving image and the sampled reference image. The edge-expanding processing is performed on the sampled moving image and the sampled reference image respectively to obtain the input moving image and the input reference image. The bed removal processing is performed on the input moving image and the input reference image to obtain the bed-removed input moving image and the bed-removed input reference image. According to the embodiments of the present disclosure, the downsampling processing, the edge-expanding processing, and the bed removal processing are performed on the target moving image and the target reference image, thereby ensuring the registration accuracy, improving the registration speed, and shortening the registration time.

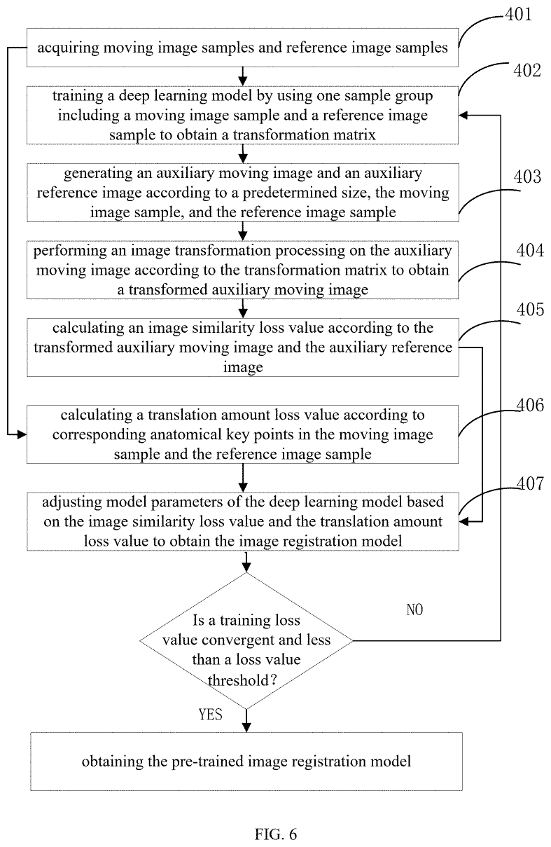

In an embodiment, as shown in FIG. 6, before the step 202 of performing the registration process on the target moving image and the target reference image by using the pre-trained image registration model to obtain the target registration parameter, the image registration method of the present disclosure includes a step of training an image registration model to obtain the pre-trained image registration model, which includes step 401 to step 407.

In step 401, moving image samples and reference image samples are acquired.

Before training the image registration model, the computer device first acquires the image samples required for training. One of the acquiring approaches may include: selecting the moving image samples and the reference image samples from a predetermined sample set.

Another sample acquiring approach may include the following steps.

In the first step, a candidate moving image and a candidate reference image are selected from the predetermined sample set.

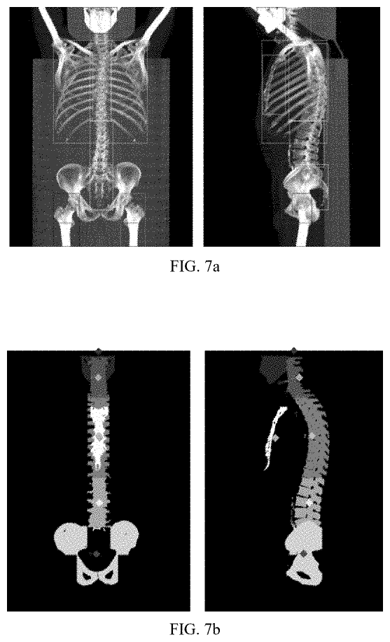

The candidate moving image and the candidate reference image have corresponding anatomical key points at corresponding positions. The anatomical key points may include at least one of a head, a cervical vertebra, a thoracic vertebra, a lumbar vertebra, a hip bone, and a sternum, as indicated by marking boxes shown in FIG. 7a and marking points shown in FIG. 7b. The anatomical key points are not limited in the embodiments of the present disclosure.

The predetermined sample set is stored in the computer device, and the candidate moving image and the candidate reference image are selected from the predetermined sample set, and the candidate moving image and the candidate reference image include the anatomical key points at the same positions.

For example, the candidate moving image and the candidate reference image selected from the predetermined sample set both include the cervical vertebrae, or, the candidate moving image and the candidate reference image selected from the predetermined sample set both contain the hip bone.

In the second step, an image cropping processing is performed on the candidate moving image and the candidate reference image respectively to obtain cropped moving images and cropped reference images.

After the candidate moving image and the candidate reference image are selected, the computer device may perform the image cropping processing on the candidate moving image and the candidate reference image respectively to obtain the cropped moving image and the cropped reference image. The purpose of the image cropping processing is to increase the number of the samples, thereby increasing diversity of the training samples.

For example, the candidate moving image A1 and the candidate reference image B1 are randomly cropped to obtain a cropped moving image A2 and a cropped reference image B2. Then, the candidate moving image A1 and the candidate reference image B1 are randomly cropped again to obtain a cropped moving image A3 and a cropped reference image B3. The cropped moving image A2 and the cropped reference image B2, and the cropped moving image A3 and the cropped reference image B3 belong to two different training sample groups. Alternatively, the size of the cropped moving image A2 is different from the size of the cropped reference image B2, and the size of the cropped moving image A3 is different from the size of the cropped reference image B3.

In practical applications, other number increasing approaches may also be employed. For example, the candidate moving image A1 and the candidate reference image B1 are rotated to obtain a rotated moving image A4 and a rotated reference image B4. The rotated moving image A4 and the rotated reference image B4, the cropped moving image A2 and the cropped reference image B2, and the cropped moving image A3 and the cropped reference image B3 are different training samples. The approach of increasing the number of the training samples is not limited in the embodiments of the present disclosure and may be set according to actual conditions.

In the third step, an image pre-processing is performed on the cropped moving images and the cropped reference images to obtain the moving image samples and the reference image samples.

After the cropped moving images and the cropped reference images are obtained, the computer device may further perform an image pre-processing, such as the downsampling processing, the edge-expanding processing, and the bed removal processing, on the cropped moving images and the cropped reference images to obtain the moving image samples and the reference image samples. The image pre-processing may ensure the registration accuracy, improve the registration speed, and shorten the registration time.

In step 402, a deep learning model is trained by using one sample group including a moving image sample and a reference image sample to obtain a transformation matrix.

During a training, the moving image sample and the reference image sample are inputted into the deep learning model, and the deep learning model transforms the moving image sample, so that the moving image sample may be registered with the reference image sample. Then, the deep learning model outputs the transformation matrix according to a result of the transformation of the moving image sample.

In step 403, an auxiliary moving image and an auxiliary reference image are generated according to a predetermined size, the moving image sample and the reference image sample.

After the moving image sample and the reference image sample are acquired, the auxiliary moving image and the auxiliary reference image may be generated according to the predetermined size, the moving image sample and the reference image sample. Specifically, it is first determined whether a size of the moving image sample and a size of the reference image sample are identical with the predetermined size. If the size of the moving image sample and the size of the reference image sample are not identical with the predetermined size, a size transformation processing is performed on the moving image sample and the reference image sample according to the predetermined size to make the size of the moving image sample and the size of the reference image sample identical with the predetermined size. The predetermined size is set according to the longest length of a side, and the size transformation processing may include the edge-expanding processing.

After the size transformation processing, the moving image sample and the reference image sample are located at centers of the auxiliary moving image and the auxiliary reference image, respectively.

In step 404, an image transformation processing is performed on the auxiliary moving image according to the transformation matrix to obtain a transformed auxiliary moving image.

After obtaining the auxiliary moving image, the computer device performs image transformation processing on the auxiliary moving image by using the transformation matrix obtained in step 402 to obtain the transformed auxiliary moving image.

In step 405, an image similarity loss value is calculated according to the transformed auxiliary moving image and the auxiliary reference image.

The image similarity loss value is calculated according to the transformed auxiliary moving image and the auxiliary reference image. The image similarity loss value may be measured by a similarity measure, such as a normalized cross-correlation, a mutual information and so on. The calculation approach is not limited in the embodiments of the present disclosure.

In step 406, a translation amount loss value is calculated according to an anatomical key point in the moving image sample and a corresponding anatomical key point in the reference image sample.

The computer device determines corresponding anatomical key points in the moving image sample and the reference image sample, determines a first position of the anatomical key point in the moving image sample, and a second position of the anatomical key point in the reference image sample, calculates a translation amount between the first position and the second position, and obtains the translation amount loss value.

In step 407, model parameters of the deep learning model are adjusted based on the image similarity loss value and the translation amount loss value to obtain the image registration model.

After the image similarity loss value and the translation amount loss value are obtained, the model parameters of the deep learning model may be adjusted according to the image similarity loss value and the translation amount loss value, so that the deep learning model is trained to obtain the image registration model.

In one of the embodiments, the step of adjusting the model parameters of the deep learning model based on the image similarity loss value and the translation amount loss value may include: calculating a weighted sum of the image similarity loss value and the translation amount loss value to obtain a total loss value, and adjusting the model parameters of the deep learning model based on the total loss value to obtain the image registration model.

It may be understood that, when the scan FOV difference between the moving image sample and the reference image sample is relatively great, the model parameters of the deep learning model may be well adjusted according to the translation amount loss value, so that the trained image registration model may be applied to a scene with a great FOV difference.

Return to perform step 402, till a training loss value is convergent and less than a loss value threshold to obtain the pre-trained image registration model.

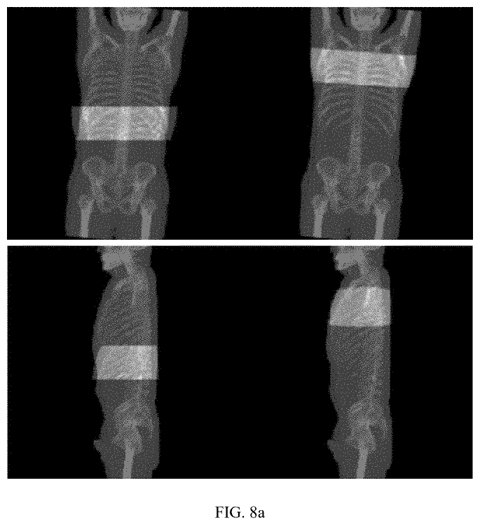

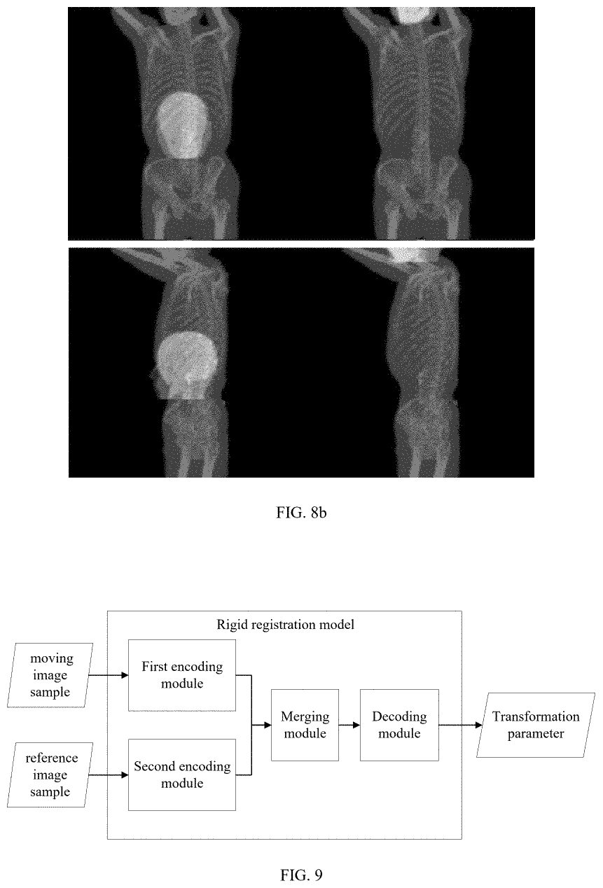

As shown in FIG. 8a, a chest CT image and a body CT image (left images of a coronal image and a sagittal image) are registered by using the image registration model. Although the scan FOV difference is relatively great, a more accurate result of registration (the right images of the coronal image and the sagittal image) may be obtained.

As shown in FIG. 8b, a head CT image and a body CT image (the left images of a coronal image and a sagittal image) are registered by using the image registration model. Although the scan FOV difference is relatively great, a more accurate result of registration (the right images of the coronal image and the sagittal image) may be obtained.

In one of the embodiments, if organ mask information is included in the moving image sample and the reference image sample, an overlap rate loss value of the organ mask may be further determined by using a Dice loss function, and the deep learning model may be further trained by using the overlap rate loss value. Compared with the embodiment using only a distance loss value of the key points, the overlap rate loss value in this embodiment may provide more information for training the image registration model.

In the above embodiment, the moving image samples and the reference image samples are acquired. The deep learning model is trained by using one sample group including the moving image sample and the reference image sample to obtain the transformation matrix. The auxiliary moving image and the auxiliary reference image are generated according to the predetermined size, the moving image sample and the reference image sample. The image transformation processing is performed on the auxiliary moving image according to the transformation matrix to obtain the transformed auxiliary moving image. The image similarity loss value is calculated according to the transformed auxiliary moving image and the auxiliary reference image. The translation amount loss value is calculated according to the anatomical key point in the moving image sample and the corresponding anatomical key point in the reference image sample. The model parameters of the deep learning model are adjusted based on the image similarity loss value and the translation amount loss value to obtain the image registration model. Return to perform the training the deep learning model by using one sample group including the moving image sample and the reference image sample to obtain the transformation matrix till the training loss value is convergent and less than the loss value threshold, to obtain the pre-trained image registration model. In the embodiments of the present disclosure, during the training of the deep learning model, the translation amount loss value, obtained according to the anatomical key points, is considered. In this way, the trained image registration model may be used to perform registration process on the moving image and the reference image, between which the scan FOV difference is greater than a predetermined difference value, and is applicable to a scene with a large scan FOV difference, so that the accuracy of the target registration parameter outputted by the image registration model is higher.

In one of the embodiments, the deep learning model includes a rigid registration model, and the step of training the deep learning model by using one sample group including the moving image sample and the reference image sample to obtain the transformation matrix may include: inputting the moving image sample and the reference image sample into the rigid registration model to obtain transformation parameters outputted by the rigid registration model; and performing a matrix transformation processing on the transformation parameters to obtain the transformation matrix.

As shown in FIG. 9, the structure of the rigid registration model includes a first encoder, a second encoder, a merging module, and a decoder. A weighting parameter in the first encoder is the same as a weighting parameter in the second encoder. During the training, the moving image sample is inputted into the first encoder, the reference image sample is inputted into the second encoder, the first encoder outputs an encoded result of the moving image sample, and the second encoder outputs an encoded result of the reference image sample. Then, the encoded result of the moving image sample and the encoded result of the reference image sample are inputted into the merging module, and the merging module merges the encoded result of the moving image sample and the encoded result of the reference image sample, and outputs a merged result. Then, the merged result is inputted into the decoding module, and the decoding module decodes the fusion result and outputs the transformation parameters. The transformation parameters may include a rotation parameter, a translation parameter, and the like, that is, parameters of six degrees of freedom (6Dof). The dimension of the transformation matrix may be 3×4, and is not limited in the embodiments of the present disclosure.

The above encoder may be an encoder of the convolutional neural network Vnet, and the merging module may be an adaptive pooling module (e.g.: AdaptiveMaxPoolin) and a channel adding module (e.g.: concate), or may be a Transformer-decoder. The decoder may include a fully-connected module. The structure of the rigid registration model is not limited in the embodiments of the present disclosure.

In one of the embodiments, the deep learning model includes an affine registration model, and the step of training the deep learning model by using one sample group including the moving image sample and the reference image sample to obtain the transformation matrix may include: inputting the moving image sample and the reference image sample into the affine registration model to obtain the transformation matrix outputted by the affine registration model.

The affine registration model may directly output the transformation matrix, without outputting the transformation parameters first and then performing the matrix transformation processing on the transformation parameters as does the rigid registration model.

In the above embodiments, the deep learning model may include at least one of the rigid registration model and the affine registration model. Therefore, the image registration model may be implemented by various model structures, so that the image registration model may be applicable to various scenes.

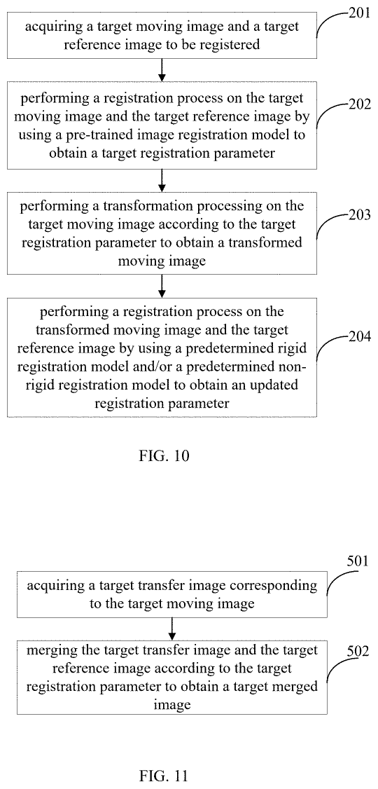

In an embodiment, after obtaining the target registration parameter, the computer device may further optimize and update the target registration parameter. As shown in FIG. 10, on the basis of the above embodiments, an embodiment of the present disclosure may further include step 203 and step 204.

In step 203, a transformation processing is performed on the target moving image according to the target registration parameter to obtain a transformed moving image.

The computer device performs the transformation processing on the target moving image according to the target registration parameter outputted by the image registration model to obtain the transformed moving image.

In step 204, a registration process is performed on the transformed moving image and the target reference image by using a predetermined rigid registration model and/or a predetermined non-rigid registration model to obtain an updated registration parameter.

At least one of the rigid registration model and the non-rigid registration model is pre-configured in the computer device. After obtaining the transformed moving image, the computer device may perform the registration process on the transformed moving image and the target reference image by using only the rigid registration model or the non-rigid registration model to obtain the updated registration parameter; or, may firstly perform a registration process on the transformed moving image and the target reference image by using the rigid registration model to obtain a registered moving image, and then perform a registration process on the registered moving image and the target reference image by using the non-rigid registration model to obtain the updated registration parameter. The approach of acquiring the updated registration parameter is not limited in the embodiments of the present disclosure.

In the above embodiments, the transformation processing is performed on the target moving image according to the target registration parameter to obtain the transformed moving image. The registration process is performed on the transformed moving image and the target reference image by using the predetermined rigid registration model and/or the predetermined non-rigid registration model to obtain the updated registration parameter. In the embodiments of the present disclosure, the target registration parameter is further updated and optimized by using the rigid registration model and/or the non-rigid registration model, so that the accuracy of the registration parameter may be improved, thereby matching and merging the images more accurately.

In an embodiment, as shown in FIG. 11, the image registration method of the present disclosure further includes a process of merging images including step 501 and step 502.

In step 501, a target transfer image corresponding to the target moving image is acquired.

The target transfer image may include an organ contour, a lesion contour, or other parameters and identifications. Transfer information in the target transfer image is not limited in the embodiments of the present disclosure.

The computer device may display the target moving image, and then acquire the organ contour, the lesion contour, and the like manually drawn by a user, thereby obtaining the target transfer image containing the organ contour, the lesion contour, and the like.

The computer device may also input the target moving image into an image recognition model, and identify an organ and a lesion from the target moving image by using the image recognition model, thereby obtaining a target transfer image including an organ contour and a lesion contour.

The approach of acquiring the target transfer image is not limited in the embodiments of the present disclosure.

In step 502, merging the target transfer image and the target reference image according to the target registration parameter to obtain a target merged image.

The computer device performs the transformation processing on the target transfer image according to the target registration parameter to obtain the transformed transfer image. Thereafter, the computer device merges the transformed transfer image and the target reference image to obtain the target merged image. Thus, the organ contour, the lesion contour, and the like in the target transfer image may be transferred to the target reference image, thereby providing a basis for clinical diagnosis and operation planning.

In the above embodiment, the target transfer image corresponding to the target moving image is acquired; and the target transfer image and the target reference image are merged according to the target registration parameter to obtain the target merged image. In this embodiment of the present disclosure, the target registration parameter is obtained by using the pre-trained image registration model, therefore, there is no problem of slow convergence, and thus the registration speed is high and the registration efficiency is high. Further, during the training of the image registration model, the translation amount loss value of the anatomical key point is used, therefore, the image registration model is applicable to the scene with the great scan FOV difference, and the target registration parameter obtained by using the image registration model has a relatively high accuracy. By merging the target transfer image and the target reference image according to the target registration parameter, the more accurate target merged image may be obtained, thereby providing an accurate basis for clinical diagnosis and operation planning.

It should be understood that, although the steps in the flowcharts of FIGS. 2 to 11 are shown in sequence indicated by arrows, but these steps are not necessarily executed in the order indicated by the arrows. Unless explicitly stated herein, these steps are not necessarily performed strictly according to an order, and these steps may be performed in any other order. Moreover, at least part of the steps in FIGS. 2 to 11 may include multiple steps or multiple stages, and these steps or stages are not necessarily executed and completed at the same time, but may be executed at different times. These steps or stages are not necessarily executed in sequence, but may be performed in turn or alternately with other steps or with at least a portion of steps or stages in the other steps.

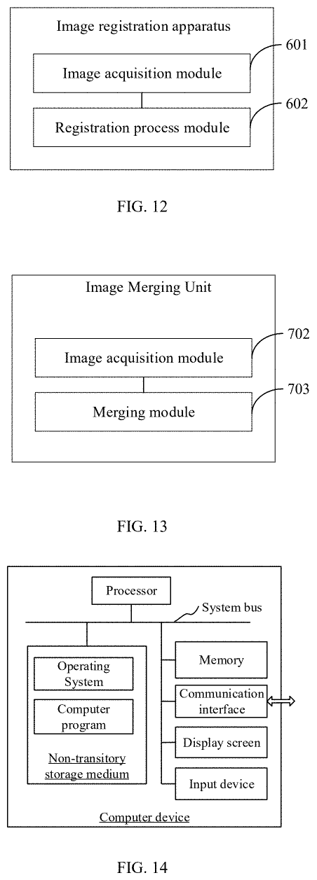

In an embodiment, as shown in FIG. 12, an image registration apparatus is provided and includes an image acquisition module 601 and a registration process module 602.

The image acquisition module 601 is configured to acquire a target moving image and a target reference image to be registered. The target moving image and the target reference image are scanned medical images with the same dimension.

The registration process module 602 is configured to perform a registration process on the target moving image and the target reference image by using a pre-trained image registration model to obtain a target registration parameter. The image registration model is a deep learning model for performing registration process on a moving image and a reference image between which a scan FOV difference is greater than a predetermined difference value.

In one of the embodiments, the registration process module 602 includes a pre-processing submodule, a registration submodule, and a post-processing submodule.

The pre-processing submodule is configured to perform an image pre-processing on the target moving image and the target reference image respectively to obtain an input moving image and an input reference image.

The registration submodule is configured to input the input moving image and the input reference image into the image registration model to obtain an initial registration parameter.

The post-processing submodule is configured to perform a post-processing on the initial registration parameter to obtain the target registration parameter.

In one of the embodiments, the pre-processing submodule is specifically configured to perform a downsampling processing on the target moving image and the target reference image respectively to obtain a sampled moving image and a sampled reference image, and perform an edge-expanding processing on the sampled moving image and the sampled reference image respectively to obtain the input moving image and the input reference image.

In one of the embodiments, the above registration process module 602 further includes a bed removal submodule.

The bed removal submodule is configured to perform a bed removal processing on the input moving image and the input reference image to obtain a bed-removed input moving image and a bed-removed input reference image.

Correspondingly, the registration submodule is specifically configured to input the bed-removed input moving image and the bed-removed input reference image into the image registration model to obtain the initial registration parameter.

In one of the embodiments, the apparatus includes a sample acquisition module, a model training module, an auxiliary image generation module, a first image transformation module, a first loss calculation module, a second loss calculation module, and a parameter adjustment module.

The sample acquisition module is configured to acquire moving image samples and reference image samples.

The model training module is configured to train a deep learning model by using one sample group including a moving image sample and a reference image sample to obtain a transformation matrix.

The auxiliary image generation module is configured to generate an auxiliary moving image and an auxiliary reference image according to a predetermined size, the moving image sample, and the reference image sample.

The first image transformation module is configured to perform an image transformation processing on the auxiliary moving image according to the transformation matrix to obtain a transformed auxiliary moving image.

The first loss calculation module is configured to calculate an image similarity loss value according to the transformed auxiliary moving image and the auxiliary reference image.

The second loss calculation module is configured to calculate a translation amount loss value according to an anatomical key point in the moving image sample and a corresponding anatomical key point in the reference image sample.

The parameter adjustment module is configured to adjust model parameters of the deep learning model based on the image similarity loss value and the translation amount loss value to obtain the image registration model.

In one of the embodiments, the deep learning model includes a rigid registration model, and the above model training module is specifically configured to input the moving image sample and the reference image sample into the rigid registration model to obtain transformation parameters outputted by the rigid registration model, and perform a matrix transformation processing on the transformation parameters to obtain the transformation matrix.

In one of the embodiments, the deep learning model includes an affine registration model, and the model training module is specifically configured to input the moving image sample and the reference image sample into the affine registration model to obtain the transformation matrix outputted by the affine registration model.

In one of the embodiments, the above parameter adjustment module is specifically configured to calculate a weighted sum of the image similarity loss value and the translation amount loss value to obtain a total loss value, and adjust the model parameters of the deep learning model based on the total loss value to obtain the image registration model.

In one of the embodiments, the sample acquisition module is specifically configured to select a candidate moving image and a candidate reference image from the predetermined sample set. The candidate moving image and the candidate reference image have anatomical key points at corresponding positions. The sample acquisition module is specifically configured to perform an image cropping processing on the candidate moving image and the candidate reference image respectively to obtain cropped moving images and cropped reference images, and is configured to perform an image pre-processing on the cropped moving images and the cropped reference images to obtain the moving image samples and the reference image samples.

In one of the embodiments, the apparatus further includes a second image transformation module and a parameter updating module.

The second image transformation module is configured to perform a transformation processing on the target moving image according to the target registration parameter to obtain a transformed moving image.

The parameter updating module is configured to perform a registration process on the transformed moving image and the target reference image by using a predetermined rigid registration model and/or a predetermined non-rigid registration model to obtain an updated registration parameter.

For the specific limitation of the image registration apparatus, a reference may be made to the above limitation on the image registration method, which will not be repeatedly described hereinafter. Each of the modules in the image registration apparatus may be implemented in whole or in part by software, hardware and combinations thereof. The above modules may be embedded in or independent of the processor in the computer device in the form of hardware, or may be stored in the memory in the computer device in the form of software, so that the processor may call and execute operations corresponding to the above modules.

In an embodiment, as shown in FIG. 13, the image registration apparatus of the present disclosure includes an image merging unit. The image merging unit includes an image acquisition module 702 and a merging module 703.

The image acquisition module 702 is configured to acquire a target transfer image corresponding to the target moving image.

The merging module 703 is configured to merge the target transfer image and the target reference image according to the target registration parameter to obtain a target merged image.

For the specific limitation of the image merging unit, reference may be made to the above limitation on the process of merging images, which will not be repeatedly described hereinafter. Each of the above modules in the image merging unit may be implemented in whole or in part by software, hardware and combinations thereof. The above modules may be embedded in or independent of the processor in the computer device in the form of hardware, or may be stored in the memory in the computer device in the form of software, so that the processor may call and execute operations corresponding to the above modules.

In an embodiment of the present application, a computer device is provided, the computer device may be a terminal, and an internal structure view thereof may be shown in FIG.14. The computer device includes a processor, a memory, a communication interface, a display screen, and an input device that are connected by a system bus. The processor of the computer device is configured to provide computing and control capabilities. The memory of the computer device includes a non-transitory storage medium, a memory. The non-transitory storage medium stores an operating system and a computer program. The memory provides an environment for running the operating system and the computer program in the non-transitory storage medium. The communication interface of the computer device is configured for wired or wireless communication with an external terminal, and the wireless communication can be realized by WIFI, operator network, near field communication (NFC) or other technologies. The computer program, when executed by the processor, implements the image registration method. The display screen of the computer device may be a liquid crystal display screen or an electronic ink display screen. The input device of the computer device may be a touch layer covering the display screen, or a button, a trackball or a touchpad provided on a housing of the computer device, or an external keyboard, a trackpad, or a mouse.

Those skilled in the art should understand that the structure shown in FIG. 14 is only a block diagram of part of the structure related to the solutions of the present application, but not constitutes a limitation on the computer device, to which the solutions of the present application is applied. The specific computer device may include more or less parts than those shown in the figure, or combine some parts, or have a different layout of parts.

In an embodiment, a computer device is provided. The computer device includes a memory and a processor. Computer programs are stored on the memory. The processor, when executing the computer programs, performs the following steps: acquiring a target moving image and a target reference image to be registered, the target moving image and the target reference image being scanned medical images with the same dimension, and performing a registration process on the target moving image and the target reference image by using a pre-trained image registration model to obtain a target registration parameter. The image registration model is a deep learning model for performing registration process on a moving image and a reference image between which a scan FOV difference is greater than a predetermined difference value.

In an embodiment, the processor, when executing the computer program, performs the following steps: performing an image pre-processing on the target moving image and the target reference image respectively to obtain an input moving image and an input reference image, inputting the input moving image and the input reference image into the image registration model to obtain an initial registration parameter, and performing a post-processing on the initial registration parameter to obtain the target registration parameter.

In an embodiment, the processor, when executing the computer program, performs the following steps: performing a downsampling processing on the target moving image and the target reference image respectively to obtain a sampled moving image and a sampled reference imaging, and performing an edge-expanding processing on the sampled moving image and the sampled reference image respectively to obtain the input moving image and the input reference image.

In an embodiment, the processor, when executing the computer program, performs the following step: performing a bed removal processing on the input moving image and the input reference image to obtain a bed-removed input moving image and a bed-removed input reference image.

Correspondingly, the inputting the input moving image and the input reference image into the image registration model to obtain the initial registration parameter includes: inputting the bed-removed input moving image and the bed-removed input reference image into the image registration model to obtain the initial registration parameter.

In an embodiment, the processor, when executing the computer program, performs the following steps: acquiring moving image samples and reference image samples, training a deep learning model by using one sample group including a moving image sample and a reference image sample to obtain a transformation matrix, generating an auxiliary moving image and an auxiliary reference image according to a predetermined size, the moving image sample, and the reference image sample, performing an image transformation processing on the auxiliary moving image according to the transformation matrix to obtain a transformed auxiliary moving image, calculating an image similarity loss value according to the transformed auxiliary moving image and the auxiliary reference image, calculating a translation amount loss value according to an anatomical key point in the moving image sample and a corresponding anatomical key point in the reference image sample, and adjusting model parameters of the deep learning model based on the image similarity loss value and the translation amount loss value to obtain the image registration model.

In an embodiment, the deep learning model includes a rigid registration mode, and the processor, when executing the computer program, performs the following steps: inputting the moving image sample and the reference image sample into the rigid registration model to obtain transformation parameters outputted by the rigid registration model, and performing a matrix transformation processing on the transformation parameters to obtain the transformation matrix.

In an embodiment, the deep learning model includes an affine registration mode, and the processor, when executing the computer program, performs the following step: inputting the moving image sample and the reference image sample into the affine registration model to obtain the transformation matrix outputted by the affine registration model.

In an embodiment, the processor, when executing the computer program, performs the following steps: calculating a weighted sum of the image similarity loss value and the translation amount loss value to obtain a total loss value, and adjusting the model parameters of the deep learning model based on the total loss value to obtain the image registration model.

In an embodiment, the processor, when executing the computer program, performs the following steps: selecting a candidate moving image and a candidate reference image from the predetermined sample set, the candidate moving image and the candidate reference image having anatomical key points at corresponding positions, performing an image cropping processing on the candidate moving image and the candidate reference image respectively to obtain cropped moving images and cropped reference images, and performing an image pre-processing on the cropped moving images and the cropped reference images to obtain the moving image samples and the reference image samples.

In an embodiment, the processor, when executing the computer program, performs the following steps: performing a transformation processing on the target moving image according to the target registration parameter to obtain a transformed moving image, and performing a registration process on the transformed moving image and the target reference image by using a predetermined rigid registration model and/or a predetermined non-rigid registration model to obtain an updated registration parameter.

In an embodiment, the present disclosure provides a non-transitory computer readable storage medium, on which computer programs are stored, and the computer programs, when being executed by a processor, cause the processor to perform following steps: acquiring a target moving image and a target reference image to be registered, the target moving image and the target reference image being scanned medical images with the same dimension, and performing a registration process on the target moving image and the target reference image by using a pre-trained image registration model to obtain a target registration parameter, the image registration model being a deep learning model for performing registration process on a moving image and a reference image between which a scan FOV difference is greater than a predetermined difference value.

In an embodiment, the computer programs, when being executed by a processor, cause the processor to perform following steps: performing an image pre-processing on the target moving image and the target reference image respectively to obtain an input moving image and an input reference image, inputting the input moving image and the input reference image into the image registration model to obtain an initial registration parameter, and performing a post-processing on the initial registration parameter to obtain the target registration parameter.

In an embodiment, the computer programs, when being executed by a processor, cause the processor to perform following steps: performing a downsampling processing on the target moving image and the target reference image respectively to obtain a sampled moving image and a sampled reference image, and performing an edge-expanding processing on the sampled moving image and the sampled reference image respectively to obtain the input moving image and the input reference image.

In an embodiment, the computer programs, when being executed by a processor, cause the processor to perform following steps: performing a bed removal processing on the input moving image and the input reference image to obtain a bed-removed input moving image and a bed-removed input reference image.

Correspondingly, the inputting the input moving image and the input reference image into the image registration model to obtain the initial registration parameter includes: inputting the bed-removed input moving image and the bed-removed input reference image into the image registration model to obtain the initial registration parameter.

In an embodiment, the computer programs, when being executed by a processor, cause the processor to perform following steps: acquiring moving image samples and reference image samples, training a deep learning model by using one sample group including a moving image sample and a reference image sample to obtain a transformation matrix, generating an auxiliary moving image and an auxiliary reference image according to a predetermined size, the moving image sample, and the reference image sample, performing an image transformation processing on the auxiliary moving image according to the transformation matrix to obtain a transformed auxiliary moving image, calculating an image similarity loss value according to the transformed auxiliary moving image and the auxiliary reference image, calculating a translation amount loss value according to an anatomical key point in the moving image sample and a corresponding anatomical key point in the reference image sample, and adjusting model parameters of the deep learning model based on the image similarity loss value and the translation amount loss value to obtain the image registration model.

In an embodiment, the deep learning model includes a rigid registration mode, and the computer programs, when being executed by a processor, cause the processor to perform following steps: inputting the moving image sample and the reference image sample into the rigid registration model to obtain transformation parameters outputted by the rigid registration model, and performing a matrix transformation processing on the transformation parameters to obtain the transformation matrix.

In an embodiment, the deep learning model includes an affine registration mode, and the computer programs, when being executed by a processor, cause the processor to perform following steps: inputting the moving image sample and the reference image sample into the affine registration model to obtain the transformation matrix outputted by the affine registration model.

In an embodiment, the computer programs, when being executed by a processor, cause the processor to perform following steps: calculating a weighted sum of the image similarity loss value and the translation amount loss value to obtain a total loss value, and adjusting the model parameters of the deep learning model based on the total loss value to obtain the image registration model.

In an embodiment, the computer programs, when being executed by a processor, cause the processor to perform following steps: selecting a candidate moving image and a candidate reference image from the predetermined sample set, the candidate moving image and the candidate reference image having anatomical key points at corresponding positions, performing an image cropping processing on the candidate moving image and the candidate reference image respectively to obtain cropped moving images and cropped reference images, and performing an image pre-processing on the cropped moving images and the cropped reference images to obtain the moving image samples and the reference image samples.

In an embodiment, the computer programs, when being executed by a processor, cause the processor to perform following steps: performing a transformation processing on the target moving image according to the target registration parameter to obtain a transformed moving image, and performing a registration process on the transformed moving image and the target reference image by using a predetermined rigid registration model and/or a predetermined non-rigid registration model to obtain an updated registration parameter.

A person of ordinary skill in the art should understand that all or part of the processes in the method of the above embodiments may be implemented by means of a computer program instructing relevant hardware. The computer program may be stored in a non-volatile computer readable storage medium. When the computer program is executed, it may include the procedures of the embodiments of the above method. Where, any reference to the memory, the storage, the database or other medium used in the embodiments provided by the present application may include at least one of non-transitory memory and transitory memory. The non-transitory memory may include read-only memory (ROM), magnetic tape, floppy disk, flash memory, or optical memory. The transitory memory may include random access memory (RAM) or external cache memory. As an illustration but not a limitation, RAM can be in various forms, such as static random access memory (SRAM) or dynamic random access memory (DRAM), etc.

The technical features of the above embodiments may be combined arbitrarily. In order to make the description concise, not all possible combinations of the technical features of the above embodiments are described. However, as long as there is no contradiction in the combination of these technical features, any combination should be within the range described in this description.

The above examples are only several embodiments of the present application, and the descriptions thereof are more specific and detailed, but they should not be understood to be a limitation on the scope of the present invention. It should be noted that, for those of ordinary skill in the art, several modifications and improvements may be made without departing from the concept of the present application, and all these modifications and improvements fall within the protection scope of the present application. Therefore, the protection scope of the present application shall be subject to the appended claims.

What is claimed is:

1. An image registration method, comprising:
acquiring a target moving image and a target reference image to be registered, and the target moving image and the target reference image being scanned medical images with the same dimension; and
performing a registration process on the target moving image and the target reference image by using a pre-trained image registration model to obtain a target registration parameter, the image registration model being a deep learning model for performing registration process on a moving image and a reference image between which a scan field of view difference is greater than a predetermined difference value.

2. The method according to claim 1, wherein, the performing the registration process on the target moving image and the target reference image by using the pre-trained image registration model to obtain the target registration parameter comprises:
performing an image pre-processing on the target moving image and the target reference image respectively to obtain an input moving image and an input reference image;
inputting the input moving image and the input reference image into the image registration model to obtain an initial registration parameter; and
performing a post-processing on the initial registration parameter to obtain the target registration parameter.

3. The method according to claim 2, wherein, the performing the image pre-processing on the target moving image and the target reference image respectively to obtain the input moving image and the input reference image comprises:
performing a downsampling processing on the target moving image and the target reference image respectively to obtain a sampled moving image and a sampled reference image; and
performing an edge-expanding processing on the sampled moving image and the sampled reference image respectively to obtain the input moving image and the input reference image.

4. The method according to claim 3, wherein
after the performing the edge-expanding processing on the sampled moving image and the sampled reference image respectively to obtain the input moving image and the input reference image, the method further comprises: performing a bed removal processing on the input moving image and the input reference image to obtain a bed-removed input moving image and a bed-removed input reference image; and
the inputting the input moving image and the input reference image into the image registration model to obtain an initial registration parameter comprises: inputting the bed-removed input moving image and the bed-removed input reference image into the image registration model to obtain the initial registration parameter.

5. The method according to claim 1, wherein, before the performing the registration process on the target moving image and the target reference image by using the pre-trained image registration model to obtain the target registration parameter, the method comprises a training process of the image registration model, and the training process of the image registration model comprises:
acquiring moving image samples and reference image samples;
training a deep learning model by using one sample group comprising a moving image sample and a reference image sample to obtain a transformation matrix;
generating an auxiliary moving image and an auxiliary reference image according to a predetermined size, the moving image sample, and the reference image sample;
performing an image transformation processing on the auxiliary moving image according to the transformation matrix to obtain a transformed auxiliary moving image;
calculating an image similarity loss value according to the transformed auxiliary moving image and the auxiliary reference image;
calculating a translation amount loss value according to an anatomical key point in the moving image sample and a corresponding anatomical key point in the reference image sample;
adjusting model parameters of the deep learning model based on the image similarity loss value and the translation amount loss value to obtain the image registration model; and
returning to perform step of training the deep learning model by using one sample group comprising the moving image sample and the reference image sample to obtain the transformation matrix, till a training loss value is convergent and less than a loss value threshold to obtain the pre-trained image registration model.

6. The method according to claim 5, wherein the deep learning model comprises a rigid registration model, and the training the deep learning model by using one sample group comprising the moving image sample and the reference image sample to obtain the transformation matrix comprises:
inputting the moving image sample and the reference image sample into the rigid registration model to obtain transformation parameters outputted by the rigid registration model; and
performing a matrix transformation processing on the transformation parameters to obtain the transformation matrix.

7. The method according to claim 5, wherein the deep learning model comprises an affine registration model, and the training the deep learning model by using one sample group comprising the moving image sample and the reference image sample to obtain the transformation matrix comprises:
inputting the moving image sample and the reference image sample into the affine registration model to obtain the transformation matrix outputted by the affine registration model.

8. The method according to claim 5, wherein the adjusting model parameters of the deep learning model based on the image similarity loss value and the translation amount loss value to obtain the image registration model comprises:
calculating a weighted sum of the image similarity loss value and the translation amount loss value to obtain a total loss value; and
adjusting the model parameters of the deep learning model based on the total loss value to obtain the image registration model.

9. The method according to claim 5, wherein step of acquiring moving image samples and reference image samples comprises:
selecting a candidate moving image and a candidate reference image from the predetermined sample set, the candidate moving image and the candidate reference image having anatomical key points at corresponding positions;
performing an image cropping processing on the candidate moving image and the candidate reference image respectively to obtain cropped moving images and cropped reference images; and
performing an image pre-processing on the cropped moving images and the cropped reference images to obtain the moving image samples and the reference image samples.

10. The method according to claim 1, wherein, after the performing the registration process on the target moving image and the target reference image by using the pre-trained image registration model to obtain the target registration parameter, the method further comprises:
performing a transformation processing on the target moving image according to the target registration parameter to obtain a transformed moving image; and
performing a registration process on the transformed moving image and the target reference image by using at least one of a predetermined rigid registration model and a predetermined non-rigid registration model to obtain an updated registration parameter.

11. The method according to claim 1, further comprising a process of merging images, wherein the process of merging images comprises:
acquiring a target transfer image corresponding to the target moving image; and
merging the target transfer image and the target reference image according to the target registration parameter to obtain a target merged image.

12. The method according to claim 5, wherein:
the moving image sample and the reference image sample comprises organ mask information; and
the training the deep learning model by using one sample group comprising the moving image sample and the reference image sample, comprising:
calculating an overlap rate loss value of organ mask by using a Dice loss function, and
training the deep learning model by using the overlap rate loss value.

13. The method according to claim 5, wherein the acquiring moving image samples and reference image samples comprises:
selecting a candidate moving image and a candidate reference image from a predetermined sample set, the candidate moving image and the candidate reference image having anatomical key points at corresponding positions;
rotating the candidate moving image and the candidate reference image respectively to obtain rotated moving images and rotated reference images; and
performing an image pre-processing on the rotated moving images and the rotated reference images to obtain the moving image samples and the reference image samples.

14. The method according to claim 2, wherein the performing the post-processing on the initial registration parameter to obtain the target registration parameter comprises:
determining that a center point of the initial registration parameter deviates according to the target moving image and the target reference image; and
calibrating the initial registration parameter according to a deviation of the center point to obtain the target registration parameter.

15. The method according to claim 5, wherein the generating the auxiliary moving image and the auxiliary reference image according to the predetermined size, the moving image sample, and the reference image sample comprises:
determining that a size of the moving image sample and a size of the reference image sample are not identical with a predetermined size; and
performing a size transformation processing on the moving image sample and the reference image sample according to the predetermined size, and making the size of the moving image sample and the size of the reference image sample identical with the predetermined size.

16. The method according to claim 5, wherein the calculating the translation amount loss value according to the anatomical key point in the moving image sample and the corresponding anatomical key point in the reference image sample comprises:
determining the anatomical key point in the moving image sample and the corresponding anatomical key point in the reference image sample;
determining a first position of the anatomical key point in the moving image sample, and a second position of the corresponding anatomical key point in the reference image sample; and
calculating a translation amount between the first position and the second position, and obtaining the translation amount loss value.

17. The method according to claim 10, wherein the performing the registration process on the transformed moving image and the target reference image by using at least one of the predetermined rigid registration model and the predetermined non-rigid registration model to obtain the updated registration parameter comprises:
performing the registration process on the transformed moving image and the target reference image by using only the rigid registration model or the non-rigid registration model to obtain the updated registration parameter.

18. The method according to claim 10, wherein the performing the registration process on the transformed moving image and the target reference image by using at least one of the predetermined rigid registration model and the predetermined non-rigid registration model to obtain the updated registration parameter comprises:
performing the registration process on the transformed moving image and the target reference image by using the rigid registration model to obtain a registered moving image; and
performing the registration process on the registered moving image and the target reference image by using the non-rigid registration model to obtain the updated registration parameter.

19. A computer device comprising a memory and a processor, wherein computer programs are stored on the memory, and the processor, when executing the computer programs, performs steps of the method of claim 1.

20. A non-transitory computer readable storage medium, on which computer programs are stored, wherein, the computer programs, when being executed by the processor, cause the processor to perform steps of the method of claim 1.
